(19) United States
(12) Patent Application Publication
(10) Pub. No.: US 2013/0278633 A1
(43) Pub. Date: Oct. 24, 2013

(54) METHOD AND SYSTEM FOR GENERATING AUGMENTED REALITY SCENE

(71) Applicant: SAMSUNG ELECTRONICS CO., LTD., Suwon-si (KR)

(72) Inventors: Min Su Ahn, Seoul (KR); Seung Ju Han, Seoul (KR); Jae Joon Han, Seoul (KR); Do Kyoon Kim, Seongam-si (KR); Yong Beom Lee, Seoul (KR)

(73) Assignee: Samsung Electronics Co., Ltd., Suwon-si (KR)

(21) Appl. No.: 13/866,218

(22) Filed: Apr. 19, 2013

Related U.S. Application Data
(60) Provisional application No. 61/636,155, filed on Apr. 20, 2012.

(30) Foreign Application Priority Data
Feb. 5, 2013 (KR) 10-2013-0012699

(51) Int. Cl. G06T 19/00

(52) U.S. Cl. CPC G06T 19/006
USPC 345/633

(57) ABSTRACT

A method and system for generating an augmented reality (AR) scene may include obtaining real world information including multimedia information and sensor information associated with a real world, loading an AR locator representing a scheme for mixing the real world information and at least one virtual object content and the real world information onto an AR container, obtaining the at least one virtual object content corresponding to the real world information using the AR locator from a local storage or an AR contents server, and visualizing AR information by mixing the real world information and the at least one virtual object content based on the AR locator.

### CROSS-REFERENCE TO RELATED APPLICATIONS

This application claims the priority benefit of Korean Patent Application No. 10-2013-0012699, filed on Feb. 5, 2013, in the Korean Intellectual Property Office, of U.S. Provisional Application No. 61/636,155, filed on Apr. 20, 2012, and of U.S. Provisional Application No. 61/637,412, filed on Apr. 24, 2012, the disclosures of which are incorporated herein by reference.

### BACKGROUND

1. Field

Example embodiments relate to a method and system for generating an augmented reality (AR) scene.

2. Description of the Related Art

Augmented reality (AR) technology may be used for displaying, through mixing, information about a virtual object created by computer technology and a real world, in the real world visible to a user. More particularly, a user may experience varied information about the real world more realistically by projecting invisible information generated using computer technology onto the real world information. Fields to which AR may be applicable include games, management of a manufacturing process, education, telemedicine, and the like. Furthermore, with interest in AR growing due to more widespread distribution of mobile terminals to which AR technology may be applied, such as, a smart phone, research is being conducted in earnest into the development of AR.

### SUMMARY

The foregoing and/or other aspects are achieved by providing a method for providing an augmented reality (AR) scene, the method including obtaining real world information including multimedia information and sensor information associated with a real world, loading an AR locator representing a scheme for mixing the real world information and at least one virtual object content and the real world information onto an AR container, obtaining, from a local storage or an AR contents server, the at least one virtual object content corresponding to the real world information, using the AR locator, and visualizing AR information by mixing the real world information and the at least one virtual object content based on the AR locator.

The method for providing the AR scene may further include analyzing the multimedia information and the sensor information to identify the at least one virtual object content corresponding to the multimedia information, and generating the AR locator based on a result of the analyzing.

The AR container may include a first area and a second area independent of one another, and the loading of the AR locator and the real world information onto the AR container may include loading the real world information onto the first area and loading the AR locator onto the second area, respectively.

The generating of the AR locator may include generating the AR locator including at least one of a three-dimensional (3D) scene description of the real world information, an AR location representing a location of the at least one virtual object content in the AR information, an AR control representing control information of the at least one virtual object content, and calibration information.

The AR control may include at least one of a point of time at which the at least one virtual object content is mixed and an identifier of the at least one virtual object content.

The point of time at which the at least one virtual object content is mixed may include a start time at which mixing of the at least one virtual object content commences or a stop time at which mixing of the at least one virtual object content terminates.

The obtaining of the at least one virtual object content may include transmitting a request including the identifier of the at least one virtual object content to the local storage or the AR contents server.

The at least one virtual object content obtained from the local storage or the AR contents server may include at least one of the identifier, a virtual object, and information about a characteristic of the virtual object of the at least one virtual object content.

The visualizing of the AR information may include generating AR information by performing rendering on the real world information and the at least one virtual object content based on the AR locator.

The method for providing the AR scene may further include receiving a selection from a user with respect to the visualized AR information for an interaction between the user and the at least one virtual object content, and correcting the AR locator in response to the selection from the user.

The virtual object may include at least one of a 3D graphics object, an audio object, a video object, an image object, and a text object.

The foregoing and/or other aspects are achieved by providing a system for providing an augmented reality (AR) scene, the system including a real world information obtaining unit to obtain real world information including multimedia information and sensor information associated with a real world, an AR container loading unit to load an AR locator representing a scheme for mixing the real world information and at least one virtual object content and the real world information onto an AR container, a virtual object content obtaining unit to obtain the at least one virtual object content corresponding to the real world information using the AR locator from a local storage or an AR contents server, an AR information visualizing unit to visualize AR information by mixing the real world information and the at least one virtual object content based on the AR locator, a memory to store the AR container and the at least one virtual object content, and an interface to receive a selection from a user and to display the AR information.

The system for providing the AR scene may further include a real world information analyzing unit to analyze the multimedia information and the sensor information to identify the at least one virtual object content corresponding to the multimedia information, and an AR locator generating unit to generate the AR locator based on a result of the analyzing.

The AR container may include a first area and a second area independent of one another, and the AR container loading unit may include a loading unit to load the real world information onto the first area and load the AR locator onto the second area, respectively.

The AR locator generating unit may include at least one of a three-dimensional (3D) scene description of the real world information, an AR location representing a location of the at least one virtual object content in the AR information, an AR control representing control information of the at least one virtual object content, and calibration information.

The AR control may include at least one of a point of time at which the at least one virtual object content is mixed and an identifier of the at least one virtual object content.

The virtual object content obtaining unit may include a virtual object content requesting unit to transmit a request including the identifier of the at least one virtual object content to the local storage or the AR contents server.

The AR information visualizing unit may include an AR information generating unit to generate an AR information by performing rendering on the real world information and the at least one virtual object content based on the AR locator.

The system for providing the AR scene may further include a user selection receiving unit to receive a selection from a user with respect to the visualized AR information for an interaction between the user and the at least one virtual object content, and an AR locator correcting unit to correct the AR locator in response to the selection from the user.

The foregoing and/or other aspects are achieved by providing a system for providing an augmented reality (AR) scene, the system including a mobile terminal to capture an image including real world information, an AR locator which includes information regarding virtual object content corresponding to the captured real world information, a virtual object content obtaining unit to receive virtual object content corresponding to the real world information using at least one identifier corresponding to the virtual object content, and an AR information visualizing unit to render the received virtual object content with the real world information using information included in the AR locator.

The mobile terminal may capture the image in real-time, and the AR locator generates a point of time in which virtual object content is to be mixed with the real world information using three-dimensional graphics corresponding to the real world information, and calibration information which maps virtual object content to the real world information.

The system may further include an interface included in the mobile terminal configured to receive an input from a user, wherein, in response to the user selecting a first virtual object among a plurality of virtual objects displayed on the mobile terminal, a second virtual object changes position relative to the first virtual object.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of embodiments, taken in conjunction with the accompanying drawings of which:

FIG. 1 is a flowchart illustrating a method for providing an augmented reality (AR) scene according to example embodiments;

FIG. 2 is a flowchart illustrating operation 120 of FIG. 1, in greater detail;

FIG. 3 is a flowchart illustrating a method for providing an AR scene according to other example embodiments;

FIG. 4 illustrates an example of AR information in a method for providing an AR scene according to example embodiments;

FIG. 5 is a block diagram illustrating a system for providing an AR scene according to example embodiments; and

FIG. 6 is a block diagram illustrating a structure of a method and system for providing an AR scene according to example embodiments.

### DETAILED DESCRIPTION

Reference will now be made in detail to embodiments, examples of which are illustrated in the accompanying drawings, wherein like reference numerals refer to like elements throughout. Embodiments are described below to explain the present disclosure by referring to the figures.

A method for providing an augmented reality (AR) scene according to example embodiments may provide an AR to a user using a mobile terminal, a global positioning system (GPS), a wearable computer, and the like. As used herein, “mobile terminal” may include all types of electronic devices that provide an AR through use of a mobile terminal including a smart phone, a blackberry, a feature phone, and the like, a tab, a pad, a personal digital assistant (PDA), a laptop, a camera, a sensor, and the like.

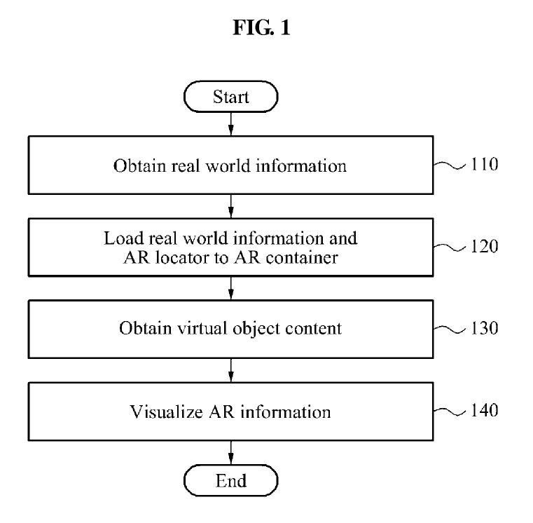

FIG. 1 is a flowchart illustrating a method for providing an AR scene according to example embodiments.

Referring to FIG. 1, in operation 110, the method for providing the AR scene may obtain real world information. A real world, a concept relative to a virtual reality, may refer to a world in which a user actually lives. The real world information, information representing a real world as a reference for an AR, may include multimedia information and sensor information associated with the real world. Multimedia associated with the real world may include stored multimedia received externally or from a previous capturing of the real world, for example, video on demand (VOD) or streaming video, and captured multimedia in which the real world is captured in real time, for example, an image captured using a camera or audio. Here, an image may include a color image, a depth image, a color and depth image, a plurality of color images, a plurality of depth images, and a plurality of color/depth images. The sensor information may be used to obtain detailed information about the real world. For example, a sensor in the method for providing the AR scene may include a GPS, an altitude sensor, a geomagnetic sensor, a position sensor, an orientation sensor, an acceleration sensor, an angular velocity sensor, and the like. Position or location information may include position information of the mobile terminal and may be related using an X, Y, Z axis and pitch, roll, and yaw information obtained via one or more sensors. Information such as time information and weather information (e.g., temperature, wind, pressure, humidity, etc.) may also be collected. The sensor information may be defined in MPEG-V (ISO/IEC 23505-5). For example, when a user uses a mobile terminal, real-time multimedia information may be obtained by capturing an image adjacent to the user through a camera built in a mobile terminal. Location information adjacent to the user may be obtained through a GPS sensor built in a mobile terminal. As an example, the user may obtain the multimedia information and the sensor information using an AR browser.

In operation 120, the method for providing the AR scene may load an AR locator and real world information onto an AR container. The AR container may be a storage space in which information necessary for generating AR information is stored, and include, for example, the AR locator and the real world information. The AR container may include an AR container included in a local device. A storage space, which may store the AR locator and real world information for example, may be realized for example, using a non-volatile memory device such as a read only memory (ROM), a random access memory (RAM), a programmable read only memory (PROM), an erasable programmable read only memory (EPROM), or a flash memory, a volatile memory device such as a random access memory (RAM), or a storage medium such as a hard disk or optical disk. However, the present invention is not limited thereto.

The AR locator may include information about a scheme for mixing the real world information and virtual object content, and the method for providing the AR scene may generate the real world information based on the AR locator. The AR locator may not include the virtual object content. However, information required for obtaining the virtual object content may be included. For example, the AR locator may include an AR location representing a location of a plurality of virtual object contents in the AR information, an AR control representing control information of the plurality of virtual object contents, or calibration information. The AR control may include at least one of a point of time at which the plurality of virtual object contents is mixed and an identifier of the plurality of virtual object contents. The point of time at which the plurality of virtual object contents is mixed may include a start time at which mixing of the plurality of virtual object contents commences and/or a stop time at which mixing of the plurality of virtual object contents terminates. The identifier may be for identifying predetermined virtual object content from among the plurality of virtual object contents, and include, for example, a query keyword representing a characteristic of the plurality of virtual object contents. According to the method for providing the AR scene, the AR location may be stored in a binary format for scene (BIFS). As an example, the BIFS may refer to a binary format for a two-dimensional (2D) or three-dimensional (3D) image and/or voice content.

The plurality of virtual object contents may be non-existent in the real world. However, the plurality of virtual object contents may refer to content mixed with the real world information to provide a wide variety of realistic information to a user, for example, 3D graphics content, audio content, video content, image content, and text content. In this instance, the plurality of virtual object contents may include the identifier of the plurality of virtual object contents and information about a characteristic of a virtual object.

In operation 130, the method for providing the AR scene may obtain, from a local storage or an AR contents server, at least one virtual object content corresponding to the real world information using the AR locator. The local storage or the AR contents server may provide a plurality of virtual object contents necessary for generating the AR information. The local storage or the AR contents server may build a database out of file information with respect to the plurality of virtual object contents. The local storage may include at least one of an internal storage or an external storage of an apparatus implementing the method for providing the AR scene. The local storage and external storage may be realized for example, using a non-volatile memory device such as a read only memory (ROM), a random access memory (RAM), a programmable read only memory (PROM), an erasable programmable read only memory (EPROM), or a flash memory, a volatile memory device such as a random access memory (RAM), or a storage medium such as a hard disk or optical disk. However, the present invention is not limited thereto.

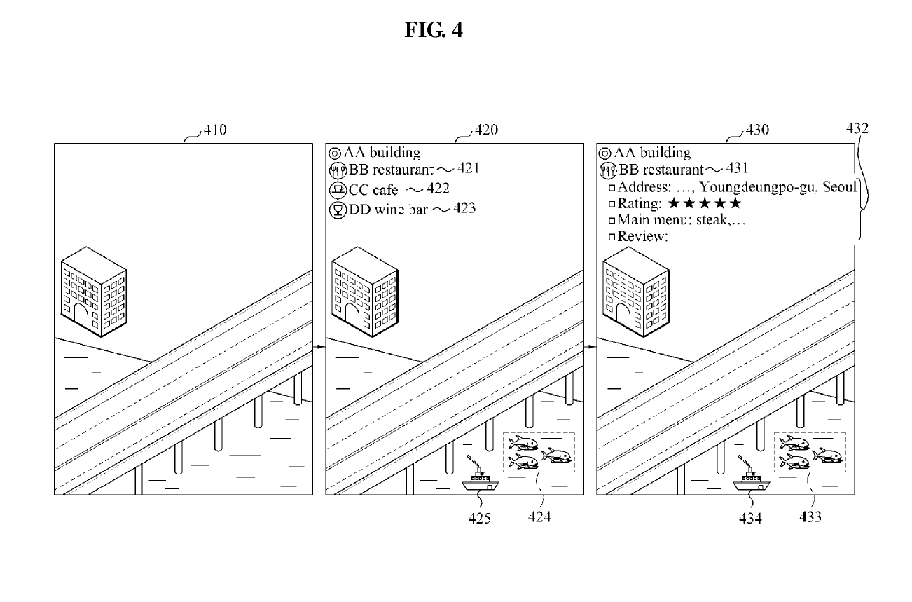

The plurality of virtual object contents of the local storage or the AR contents server may include at least one of the identifier of the plurality of virtual object contents, the virtual object of the plurality of virtual object contents, and the information about the characteristic of the virtual object. For example, the plurality of virtual object contents may include a single identifier, at least one virtual object, and at least one piece of information about the characteristic of the virtual object. The identifier of the plurality of virtual object contents may correspond to an identifier included in the AR control of the AR locator. The virtual object may include at least one of a 3D graphics object, an audio object, a video object, an image object, and a text object. The information about the characteristic of the virtual object may be descriptions of resources associated with a plurality of virtual objects, and include at least one of, for example, an animation, a sound, an appearance, haptic resources, and a behavioral model. For example, with reference to FIG. 4 which will be discussed in more detail later, virtual object content 425 may include an identifier (e.g., an identifier label, the name of the ship, or a unique identifier which may be used to retrieve a virtual object from a database or storage, etc.), a virtual object (e.g., a graphics object of the ship, a video object of the ship, etc.), and information about the characteristic of the virtual object (e.g., text regarding times of departure, advertising information, fare information, the name of the ship, animation effects showing the ship traveling or smoke from the smokestacks, sound effects, etc.).

The behavioral model may refer to information for mapping an input event with respect to the virtual object and an output event associated with the input event, may include interaction information with a user or interaction information between a virtual object and another virtual object. More particularly, the interaction information with the user may include information about a movement, a location, a state, and the like, of a virtual object when the user selects the virtual object. The interaction information between the virtual object and the other virtual object may include information about a type of the virtual object, a movement between a plurality of virtual objects based on a state of the plurality of virtual objects, location change, or state change. The state of the plurality of virtual objects may refer to a state of an inclination, a direction, a distance between the plurality of virtual objects. For example, an interaction between a deer image object and a lion image object may display a movement in which the deer image object becomes distant from the lion image object when the deer image object and the lion image object are adjacent to each other. That is, a scene may be shown to the user via the mobile terminal of the deer running away from the lion.

In the method for providing the AR scene, the plurality of virtual object contents may include uniform resource locator (URL) information of the virtual object. The URL information of the virtual object may refer to a reference of an object descriptor instructing an elementary stream associated with the plurality of virtual object contents. In this instance, the elementary stream may refer to a video or audio stream prior to being compressed.

The real world information and the AR locator may be loaded onto the AR container, respectively. The method for providing the AR scene may request the virtual object content from the local storage or the AR contents server, using the AR locator. More particularly, the AR locator may include the identifier of the plurality of virtual object contents. The plurality of virtual object contents of the local storage or the AR contents server may also include the identifier. Accordingly, virtual object content to be mixed may be identified by matching the identifier of the AR locator and the identifier of the plurality of virtual object contents of the local storage and the AR contents server. When the requested virtual object content is identified, the method for providing the AR scene may receive the virtual object content identified from the local storage or the AR contents server. Communication between the mobile terminal which may include the apparatus implementing the method for providing the AR scene, and the local storage and/or AR contents server, may be performed over a wired or wireless network, or a combination thereof, for example.

In operation 140, the method for providing the AR scene may visualize the AR information by mixing the real world information and the at least one virtual object content based on the AR locator. More particularly, the AR information may be generated by performing rendering on the virtual object content corresponding to a plurality of objects of the real world information included in the AR container, using the AR location and the AR control included in the AR locator. The rendering may be performed on the plurality of virtual object contents at a precise location, using the calibration information included in the AR locator. The method for providing the AR scene may display the AR information generated through a display device such as a screen.

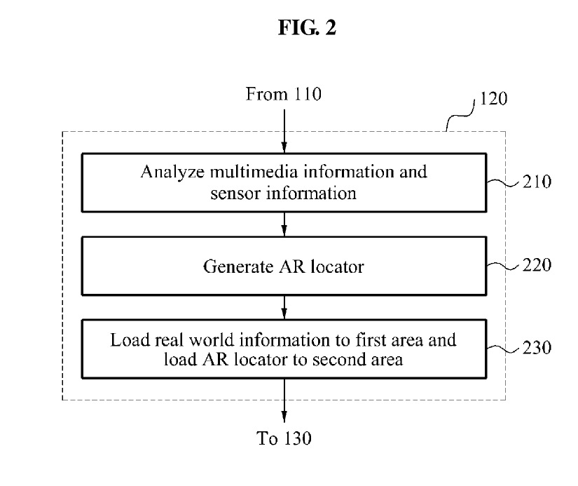

FIG. 2 is a flowchart illustrating operation 120 shown in FIG. 1 in greater detail.

Referring to FIG. 2, in operation 210, a method for providing an AR scene may analyze multimedia information and sensor information included in real world information. When the multimedia information is an image, the method for providing the AR scene may analyze object information, location information, time information, a scene description, and the like, with respect to the image. The object information may include information about a type of a plurality of objects, for example, a building, river, mountain, and the like, a size of the object, an area of the object, and the like, in a real world displayed in the image. The location information may refer to a location at which the plurality of objects is displayed in the image, and the time information may refer to a point of time at which the plurality of objects is displayed. The scene description may refer to a description of a spatio-temporal relationship of elements, such as a video, an audio, a text, graphics, and the like, configuring a scene of the image. For example, with reference to FIG. 4 which will be discussed in more detail later, a mobile terminal (e.g., including a camera, GPS, sensors, etc.), may be used to capture an image such as that shown in image 410, which includes a bridge, river, and building. Information regarding these real-world objects may be analyzed with respect to the time and location information obtained by the mobile terminal regarding the image.

Real-time multimedia information capturing the real world in real time may analyze the real-time multimedia information and sensor information together. More particularly, the sensor information may include at least one of camera information, AR camera information, location information, global position information, altitude information, geomagnetic information, position information, orientation information, and angular velocity information. When the real-time multimedia information is an image, the method for providing the AR scene may extract an object through an image analysis, and analyze a current location of a user and a current location of the object based on the sensor information. Time information may be embedded in the image, or may be obtained separately (e.g., via a GPS).

In operation 220, the method for providing the AR scene may generate an AR locator. As described above, the AR locator may refer to a scheme for mixing the real world information and the virtual object content. The AR locator may be generated based on an analysis of the real world information. For example, the AR locator may determine a type and a location of a real world object based on an analysis of the multimedia information and the sensor information, and based on a result of the determination, generate information about the type of the virtual object content to be mixed, a point of time at which the virtual object content is mixed, and the like. For example, with reference to FIG. 4 which will be discussed in more detail later, the AR locator may determine based on an analysis of image 410 a real world object of a river present in the image, and may further determine using location information for example that the river is the Han River in Seoul, South Korea. Using this information the AR locator may generate information about the type of virtual object content to be mixed. For example, virtual object content 425 (including a ship as a virtual object) and virtual object 424 (including fish as a 3D graphics object) may be generated. The AR locator may further determine where in the display or image the virtual object content should be arranged. For example, the virtual object content may be arranged based on a predetermined scheme or template, or may be arranged based on the real world information. Thus, a virtual image object type and a virtual 3D graphics object type may refer to example types of virtual object contents which may be selected based upon the analysis of the real-world information obtained through the image captured by the mobile terminal.

In particular, the AR locator may include a 3D scene description of the real world information, an AR location representing a location of a plurality of virtual object contents, an AR control representing control information of the virtual object content, and calibration information. The 3D scene description may refer to a spatio-temporal relationship of 3D graphics, and include information about the 3D graphics of the real world information.

The calibration information may measure and adjust a parameter in advance for a precise perception of an object. The calibration information may be used for mapping the virtual object content on the real world information at a precise location. The parameter may include a field of view (FOV), a sensor offset, and the like. As an example, the calibration information may include rotation information between the real world object and the virtual object, translation information, scale information, and/or scale orientation information.

The AR location may indicate a location of the at least one virtual object content in the AR information.

The AR control may refer to control information about a scheme or template for mixing the plurality of virtual object contents with the real world information. More particularly, the AR control may include at least one of the point of time at which the plurality of virtual object contents is mixed, the identifier of the plurality of virtual object contents, and information about a characteristic of a plurality of virtual objects. The point of time at which the plurality of virtual object contents is mixed may include a start time at which mixing of the plurality of virtual object contents commences and a stop time at which mixing of the plurality of virtual object contents terminates.

That is, the AR locator may map the virtual object content on the real world information at a precise location and at precise times according to the calibration information and the AR control. That is, a user may capture a real-world image in real-time, and may move the mobile terminal. Therefore, virtual object content mixed with a first real-world image captured by the user may be inapplicable to a second real-world image capture by the user. Thus, the AR control may determine a start time at which virtual object content is mixed with a real world image, and a stop time at which mixing of the virtual object content terminates. In another aspect, a mobile terminal may be moved (e.g., tilted, rotated, etc.), and a relative disposition of the real world object and the virtual object may need to be altered or adjusted (e.g., via a rotation, translation, scale change of the virtual object), so that mapping the virtual object content on the real world information at a precise location can be performed.

In operation 230, the method for providing the AR scene may load the real world information onto a first area, and load the AR locator onto a second area in the AR container, respectively. The first area may provide multimedia information and sensor information, a basis of the AR information, by including the real world information. The second area may mix the real world information and the virtual object content based on the AR locator, by including the AR location. The user may obtain the real world information and the AR locator from the AR container, using an AR browser.

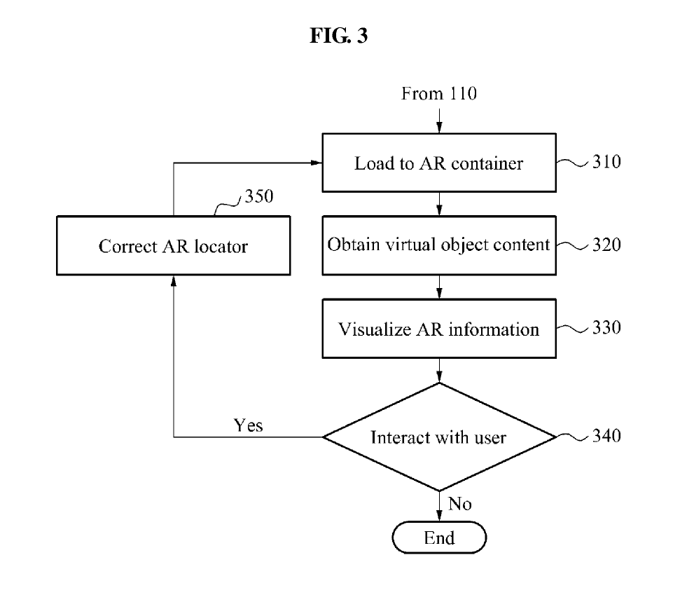

FIG. 3 is a flowchart illustrating a method for providing an AR scene according to other example embodiments.

Referring to FIG. 3, the method for providing the AR scene may provide AR information corresponding to an interaction with a user. More particularly, in operation 310, the method for providing the AR scene may load real world information and an AR locator onto an AR container. The AR locator may be generated based on an analysis of the real world information.

At least one virtual object content corresponding to an AR control included in the AR locator may be obtained from a local storage or an AR contents server in operation 320, and visualized through AR information being generated based on the at least one virtual object content obtained, in operation 330. The at least one virtual object content may be obtained from the local storage and/or AR contents server, over a wired or wireless network, or a combination thereof, for example.

In operation 340, the method for providing the AR scene may interact with the user based on the visualized AR information. More particularly, the AR information may be provided to the user through being displayed on a screen. The AR information may include real world information, a virtual object, and information about a characteristic of the virtual object. The method for providing the AR scene may include receiving a selection from the user with respect to the at least one virtual object content from the visualized AR information. For example, the user may select one of a plurality of virtual objects of the visualized AR information using a touch gesture, and the method for providing the AR scene may receive the selection from the user. Alternatively, the user may select one of a plurality of virtual objects of the visualized AR information using a keyboard, or other input device, (e.g., a stylus, mouse, or through voice commands), and the method for providing the AR scene may receive the selection from the user. The virtual object may refer to a 3D graphics object, a video object, an image object, or a text object. The method for providing the AR scene may receive the selection from the user when interaction information with the user from among information about the characteristic of the virtual object is only about a predetermined virtual object. For example, when the virtual object selected from the user fails to include the interaction information with the user, the method for providing the AR scene may not receive the selection from the user. The interaction information may include movement information, location information, state information, and the like, of a virtual object when the user selects the virtual object. For example, when a car image object is selected, the state information may be set to enlarge a size of the car image object. Likewise, with reference to FIG. 4 which will be discussed in more detail later, a user may select virtual object 424 (including fish as a 3D graphics object), and in response to the user selection, the state information may be set to enlarge a size of the 3D graphics object showing the fish.

In operation 350, the method for providing the AR scene may correct the AR locator in response to the selection from the user. Here, the method for providing the AR scene may provide different AR information to the user when the user selects a visualized virtual object. More particularly, when the selection from the user with respect to the virtual object is received, the method for providing the AR scene may correct at least one of a 3D scene description of the AR locator, an AR location, an AR control, or calibration information, corresponding to interaction information with the user predetermined for the selected virtual object. For example, when new virtual object content is mixed with the real world information through the interaction with the user, the AR locator may be corrected. In this instance, an identifier of the new virtual object, a point of time at which the new virtual object is mixed, and a location of the new virtual object may be corrected because receiving a new virtual object is required.

When the AR locator is corrected in response to the selection from the user, the method for providing the AR scene may load the corrected AR locator onto the AR container in operation 310. The new virtual object content corresponding to the corrected AR locator may be obtained from the local storage or the AR contents server in operation 320, and new AR information may be generated and visualized by mixing the real world information and the obtained new virtual object content in operation 330.

FIG. 4 illustrates an example of AR information 420 in a method for providing an AR scene according to example embodiments.

Referring to FIG. 4, a user may obtain real world information 410 using a mobile terminal. Multimedia information such as image information may be obtained by capturing a real world image with a built-in camera of the mobile terminal. Sensor information may be obtained using a built-in sensor of the mobile terminal. The method for providing the AR scene may analyze the real world information 410 based on the image information and the sensor information. More particularly, information about a current location of the user (or the mobile terminal) and a current location of an object may be obtained by extracting object information, time information, a scene description, and the like, through analyzing the image information, and by determining a location, an altitude, a geomagnetism, a position, an orientation, an angular velocity, and the like, through analyzing the sensor information. For example, the method for providing the AR scene may perceive an object such as a building, a bridge, a river, and the like, in the real world information 410, and obtain information about a location of the user, a location of the building, a location of the bridge, and a location of the river.

The method for providing the AR scene may generate the AR information 420 by mixing the real world information 410 and virtual object content. The virtual object content may include image and text object contents, 3D graphics object content, and image object content. More particularly, the method for providing the AR scene may analyze the real world information 410 and generate an AR locator. In particular, at least one of a 3D scene description of the real world information 410, an AR location, and calibration information may be generated. An AR control including an identifier of a plurality of virtual object contents, and a point of time at which the plurality of virtual object contents is mixed may be generated. The method for providing the AR scene may request a reception of the plurality of virtual object contents from a local storage or an AR contents server. For example, the method for providing the AR scene may include transmitting an identifier of ship virtual object content 425 to the AR contents server. The method for providing the AR scene may receive the ship virtual object content 425 identified by the local storage or the AR contents server as the ship virtual object content 425 corresponding to the identifier.

The method for providing the AR scene may generate the AR information 420 by rendering the received plurality of virtual object contents 421 through 425 with the real world information 410. The plurality of virtual object contents 421 through 425 and the real world information 410 may be rendered based on a point of time at which the plurality of virtual object contents of the AR control is mixed. The plurality of virtual object content 421 through 425 and the real world information 410 may be rendered more precisely based on the calibration information and the 3D scene description.

The method for providing the AR scene may display the generated AR information 420 on a display screen of the mobile terminal. For example, the generated AR information 420 may be displayed simultaneously with the real world image obtained by the mobile terminal. The AR information 420 may be displayed simultaneously with the real world image by mixing (combining) together the real world image and AR information. For example, the AR information may be displayed using an overlay, or by displaying the AR information translucently. The AR information may also be displayed three-dimensionally, for example. When information about a characteristic of the plurality of virtual objects includes interaction information between the plurality of virtual objects, a state of the plurality of virtual objects may change corresponding to the interaction information between the plurality of virtual objects. For example, when the ship image object content 425 is located adjacent to the fish 3D graphics object 424, the fish 3D graphics object 424 may display a movement through which the fish 3D graphics object 424 becomes distant from the ship image object content 425, through interaction information with the ship image object content 425. For example, in response to a user selecting one of the ship image object content 425 or the fish 3D graphics object 424, the fish 3D graphics object 424 may display a movement through which the fish 3D graphics object 424 swims away from the ship image object content 425.

The method for providing the AR scene may provide the AR information corresponding to the interaction with the user when the information about the characteristic of the virtual object includes the interaction information with the user. For example, when the plurality of image and text objects 421 through 423 includes the interaction information with the user, and the user selects one image and text object 421 of the plurality of image and text objects 421 through 423, the method for providing the AR scene may receive the selection from the user. The method for providing the AR scene may correct the AR locator in response to the selection from the user. The method for providing the AR scene may obtain new image and text object 432 from the AR container, corresponding to the corrected AR locator, and visualize new AR information 430 corresponding to the interaction with the user by rendering the real world information 410 and the obtained new image and text object 432. For example, in response to the user selecting image and text object 421 which corresponds to “BB restaurant”, new AR information 430 may be generated, and image and text object 432 may be obtained which corresponds to the selected image and text object 431. For example, address information, rating information, menu information, and review information may be displayed corresponding to the selected “BB restaurant”. Additionally, as can be seen from FIG. 4 and new AR information 430, other image and text objects 422 through 423 may be selectively omitted, for example, due to space or display constraints.

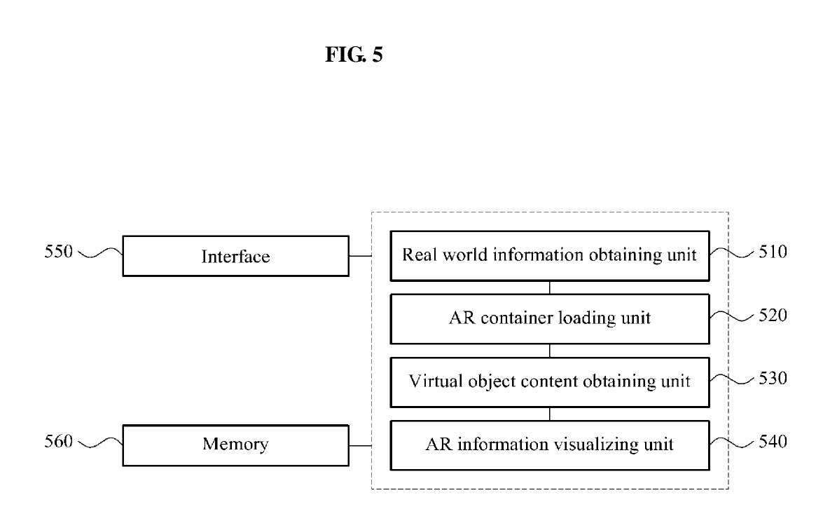

FIG. 5 is a block diagram illustrating a system for providing an AR scene according to example embodiments.

Referring to FIG. 5, an apparatus implementing the method for providing the AR scene may include a real world information obtaining unit 510, an AR container loading unit 520 a virtual object content obtaining unit 530, and an AR information visualizing unit 540. The real world information obtaining unit 510 may obtain real world information including multimedia information and sensor information associated with a real world. The real world information obtaining unit 510 may obtain real world information from a camera (an image or movie, for example), a microphone (audio data, for example), sensors (position information, for example), a GPS (location information, for example), and the like.

An AR container loading unit 520 may load an AR locator representing a scheme or template for mixing the real world information and at least one virtual object content and the real world information onto an AR container.

A virtual object content obtaining unit 530 may obtain, from a local storage or an AR contents server, at least one virtual object content corresponding to the real world information using the AR locator. The virtual object content obtaining unit 530 may obtain the at least one virtual object content from a server or local storage via a wired or wireless network.

An AR information visualizing unit 540 may visualize the AR information by mixing the real world information and the at least one virtual object content based on the AR locator.

An interface 550 may receive a selection from a user and display the AR information. The interface 550 may include, for example, a touch screen, keyboard, or other input device, for example.

A memory 560 may store the AR container and the at least one virtual object content. The memory 560 may include, for example, a non-volatile memory device such as a read only memory (ROM), a random access memory (RAM), a programmable read only memory (PROM), an erasable programmable read only memory (EPROM), or a flash memory, a volatile memory device such as a random access memory (RAM), or a storage medium such as a hard disk or optical disk. However, the present invention is not limited thereto.

Further descriptions will be omitted because the same aspects described above with respect to FIGS. 1 to 4 may be applied to the system for providing the AR scene according to the example embodiments illustrated in FIG. 5.

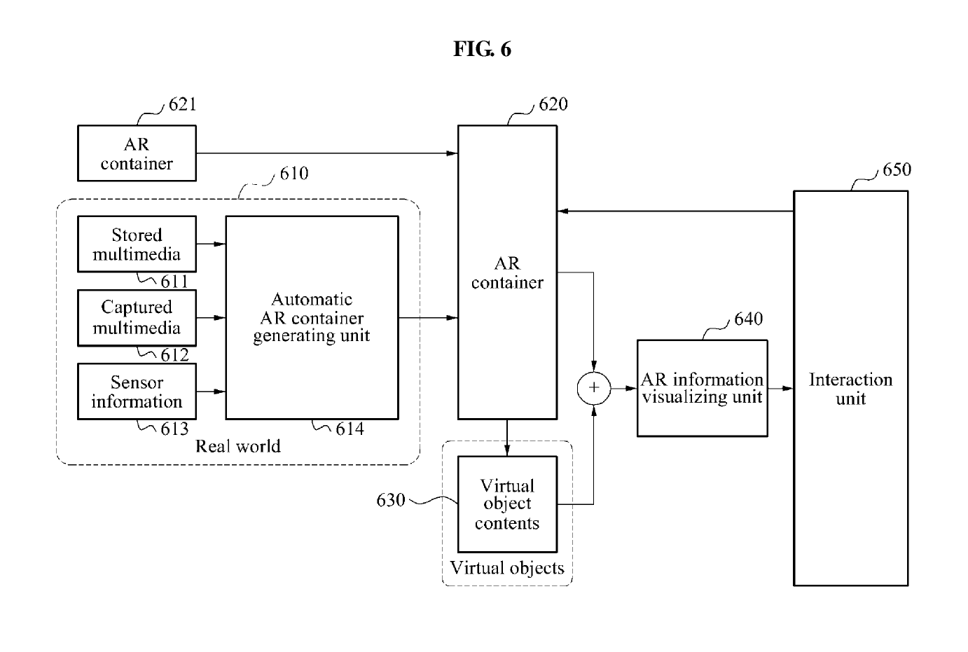

FIG. 6 is a block diagram illustrating a structure of a method and system for providing an AR scene according to example embodiments.

Referring to FIG. 6, the method and system for providing the AR scene may include a first AR container 620 and virtual object contents 630. More particularly, using an AR browser, a user may obtain a second AR container 621 included in a local device. The user may obtain stored multimedia 611, captured multimedia 612, and sensor information 613 from a real world. The stored multimedia 611 may refer to multimedia received externally or multimedia capturing the real world previously, and may be in a form of an MPEG Audio/Video format. The captured multimedia 612 may refer to multimedia capturing the real world in real time, and may be in a form of the MPEG Audio/Video format. The sensor information 613 may be in a form of an MPEG-V format. The stored multimedia 611, the captured multimedia 612, and the sensor information 613 may be loaded onto the AR container 620 using an automatic AR container generating unit 614. The user may access the virtual object contents 630 through an AR locator (not shown). The AR locator may include an AR location representing a location of a plurality of virtual object contents in the AR information, an AR control representing control information of the plurality of virtual object contents, or calibration information, and the AR location may be stored in a binary format for scene (BIFS).

The AR container 620 may be a space in which information necessary for generating the AR information is stored, and include real world information such as the stored multimedia 611, the captured multimedia 612, and the sensor information 613 and the AR locator. The virtual object contents 630 may be stored in a local storage and/or an AR contents server, and include 3D graphics content, audio content, video content, text content, and the like. The plurality of virtual object contents may include an identifier of the plurality of virtual object contents and information about a characteristic of a virtual object. The 3D graphics content may be in a form of an MPEG 3DG format, and the information about the characteristic of the virtual object may be in a form of the MPEG-V format.

An AR information visualization unit 640 may visualize the AR information by mixing the real world information and the virtual object content 630 based on the AR locator included in the AR container 620. The interaction unit 650 may perform an interaction between the user and the plurality of virtual objects based on the visualized AR information. In this instance, the interaction unit 650 may use a form of an MPEG-V/U format. The interaction unit 650 may update the AR locator included in the AR container 620.

Hereinafter, an extensible markup language (XML) description for programming a systematic structure of the method and system for providing the AR scene will be exemplified, and a function and semantics of the method and the system will be disclosed according to example embodiments. The AR container, the AR locator, the AR control, and the virtual object content may be described as follows.

### 1. AR Container

### 1.1 XML Description

```
TABLE 1
<complexType name=“ARContainerType”>
      <all>
            <element ref=“xmta:IS” minOccurs=“0”/>
            <element name=“Media” type=“xmta:MovieTextureType” minOccurs=“1”
maxOccurs=“unbounded”/>
            <element name=“Locator” form=“qualified” minOccurs=“0”>
                  <complexType>
                        <group ref=“xmta:ARLocatorType” minOccurs=“1”
maxOccurs=“unbounded”/>
                  </complexType>
            </element>
            <element name=“SceneDescription” form=“qualified” minOccurs=“0”>
                  <complexType>
                        <group ref=“xmta:IndexedFaceSetType” minOccurs=“0”/>
                  </complexType>
            </element>
      <!-- Sensor -->
      <element name=“Camera” type=“MPEG-V:siv:CameraType” minOccurs=“0”/>
      <element name=“ARcamera” type=“MPEG-V:siv:ARCameraType” minOccurs=“0”/>
      <element name=“Location” type=“MPEG-V:siv:GlobalPositionSensorType”
minOccurs=“0”/>
      <element name=“Altitude” type=“MPEG-V:siv:AltitudeSensorType” minOccurs=“0”/>
      <element name=“Geomagnetic” type=“MPEG-V:siv:GeomagneticSensorType”
minOccurs=“0”/>
      <element name=“Position” type=“MPEG-V:siv:PositionSensorType” minOccurs=“0”/>
      <element name=“Orientation” type=“MPEG-V:siv:OrientationSensorType”
minOccurs=“0”/>
      <element name=“Acceleration” type=“MPEG-V:siv:AccelerationSensorType”
minOccurs=“0”/>
      <element name=“AngularVelocity” type=“MPEG-V:siv:AngularVelocitySensorType”
minOccurs=“0”/>
</all>
      <attributeGroup ref=“xmta:DefUseGroup”/>
</complexType>
<element name=“ARContainer” type=“xmta:ARContainerType”/>
```

### 1.2 Functionality

The AR container may be used to represent a real world, and to define controlling of the real world and virtual objects. Multimedia information and sensor information may represent the real world. The sensor information may be configured by several types. For example, several types may be described by MPEG-V (ISO/IEC 23505-5).

### 1.3 Semantics

### Semantics of ARContainerType:

TABLE 2

| Name | Definition |
|---|---|
| Media | Describes a video file from a real world. |
| Locator | Describes an AR locator, which represents how to |
| | mix virtual objects in the real world and virtual object |
| | contents (or AR contents) using a structure defined |
| | by ARLocator |
| SceneDescription | Describes a scene description for the real |
| | world generated from media. |
| Camera | Describes the camera in the real world using a |
| | structure defined by CameraType in MPEG-V. |
| ARCamera | Describes an AR camera using a structure defined by |
| | ARCameraType. |
| Location | Describes a location in the real world using a structure |
| | defined by GlobalPositionSensorType in MPEG-V. |
| Altitude | Describes an altitude in the real world using a structure |
| | defined by AltitudeSensorType in MPEG-V. |
| Geomagnetic | Describes geomagnetic information in the real world |
| | using a structure defined by GeomagneticSensorType |
| | in MPEG-V. |
| Position | Describes a position in the real world using a structure |
| | defined by PositionSensorType in MPEG-V. |
| Orientation | Describes an orientation in the real world using a |
| | structure defined by OrientationSensorType in |
| | MPEG-V. |
| Acceleration | Describes acceleration sensor information in the real |
| | world using a structure defined by |
| | AcceleationSensorType in MPEG-V. |
| AngularVelocity | Describes angular velocity sensor information in the |
| | real world using a structure defined by |
| | AugularVelocitySensorType in MPEG-V. |

### 2. AR Locator

### 2.1 XML Description

```
TABLE 3
<complexType name=“ARLocatorType”>
      <all>
            <element ref=“xmta:IS” minOccurs=“0”/>
            <element name=“Control” form=“qualified” minOccurs=“0”>
                  <complexType>
                        <group ref=“xmta:ARControlType” minOccurs=“0”/>
                  </complexType>
            </element>
      </all>
      <attribute name=“location” type=“xmta:SFVec3f” use=“optional” default=“0 0 0”/>
      <!-- Calibration -->
      <attribute name=“rotation” type=“xmta:SFRotation” use=“optional” default=“0 0 1 0”/>
      <attribute name=“translation” type=“xmta:SFVec3f” use=“optional” default=“0 0 0”/>
      <attribute name=“scale” type=“xmta:SFVec3f” use=“optional” default=“1 1 1”/>
      <attribute name=“scaleOrientation” type=“xmta:SFRotation” use=“optional”
default=“0 0 1 0”/>
      <attributeGroup ref=“xmta:DefUseGroup”/>
</complexType>
<element name=“ARLocator” type=“xmta:ARLocatorType”/>
```

### 2.2 Functionality

The AR locator may be used to describe a position and a location representing virtual objects, and to describe a method for controlling the real world and the virtual objects. The AR locator may include an AR control to control the virtual objects included in the virtual object content.

### 2.3 Semantics

### Semantics of the ARLocatorType:

TABLE 4

| Name | Definition |
|---|---|
| Control | Describes which virtual object content (or AR content) |
| | is mixed with the real world and when virtual objects |
| | in the virtual object content (or AR content) appear |
| | and disappear. |
| location | Describes a position of the virtual object content |
| | (or AR content). |
| rotation | Describes a rotation in order to calibrate coordinates of |
| | virtual objects to those of the real world. |
| translation | Describes a translation in order to calibrate coordinates |
| | of virtual objects to those of the real world. |
| scale | Describes a scale value in order to calibrate |
| | coordinates of virtual objects to those of the real |
| | world. |
| scaleOrientation | Describes a scale orientation in order to calibrate |
| | coordinates of virtual objects to those of the real |
| | world. |

### 3. AR Control

### 3.1 XML Description

TABLE 5

```
<complexType name=“ARControlType”>
      <all>
            <element ref=“xmta:IS” minOccurs=“0”/>
      </all>
      <attribute name=“contentID” type=“xmta:SFInt32”
      use=“optional”/>
      <attribute name=“startTime” type=“xmta:SFTime”
      use=“optional” default=“0.0”/>
      <attribute name=“stopTime” type=“xmta:SFTime”
      use=“optional” default=“0.0”/>
      <attributeGroup ref=“xmta:DefUseGroup”/>
</complexType>
<element name=“ARControl” type=“xmta:ARControlType”/>
```

### 3.2 Functionality

The AR control may be used to control a point of time at which the virtual objects of the virtual object contents is displayed, including a start time and a stop time.

### 3.3 Semantics

### Semantics of the ARControlType:

TABLE 6

| Name | Definition |
|---|---|
| contentID | Describes an identifier (ID) of virtual object content (or AR |
| | content), which is mixed with the real world. |
| startTime | Describes a point of time at which mixing of the virtual object |
| | content (or AR content) commences. |
| StopTime | Describes a point of time at which mixing of the virtual object |
| | content (or AR content) terminates. |

### 4. Virtual Object Content (or AR Content)

### 4.1 XML Description

```
TABLE 7
<complexType name=“ARContentType”>
      <all>
            <element ref=“xmta:IS” minOccurs=“0”/>
            <element name=“Graphics” form=“qualified” minOccurs=“0”>
                  <group ref=“xmta:IndexedFaceSetType” minOccurs=“0”/>
            </element>
            <element name=“Audio” form=“qualified” minOccurs=“0”>
                  <group ref=“xmta:AudioSourceType” minOccurs=“0”/>
            </element>
            <element name=“Video” form=“qualified” minOccurs=“0”>
                  <group ref=“xmta:MovieTextureType” minOccurs=“0”/>
            </element>
            <element name=“Characteristic” form=“qualified” minOccurs=“0”>
                  <group ref=“vwoc:VWOBehaviorModeListType” minOccurs=“0”/>
            </element>
      </all>
      <attribute name=“contentID” type=“xmta:SFInt32” use=“optional”/>
      <attribute name=“url” type=“xmta:MFUrl” use=“optional”/>
      <attributeGroup ref=“xmta:DefUseGroup”/>
</complexType>
<element name=“ARContent” type=“xmta:ARContentType”/>
```

### 4.2 Functionality

Virtual object content may refer to virtual objects. The virtual objects may include at least three different types, including 3D graphics, videos/images, and audio. Information about a characteristic of the virtual objects may refer to a feedback with respect to an interaction between a user and the virtual objects.

### 4.3 Semantics

TABLE 8

| Name | Definition |
|---|---|
| Graphics | Describes 3D graphics objects, which represent virtual |
| | objects of virtual object content (or AR content). |
| Audio | Describes audio, which represent virtual objects of the |
| | virtual object content (or AR content). |
| Video/Image | Describes videos/images, which represent virtual objects |
| | of the virtual object content (or AR content). |
| Characteristic | Describes resources associated with plurality of virtual |
| | objects, such as animation, sound, appearance, haptic |
| | resources, or a behavioral model, which maps input |
| | events with respect to virtual objects and their |
| | associated output events. |
| url | Describes a reference to an object descriptor, which |
| | instructs an elementary stream associated with the |
| | virtual object content (or AR content). |

A portable device applicable to the above-described embodiments may include mobile communication devices, such as a personal digital cellular (PDC) phone, a personal communication service (PCS) phone, a personal handy-phone system (PHS) phone, a Code Division Multiple Access (CDMA)-2000 (1×, 3×) phone, a Wideband CDMA phone, a dual band/dual mode phone, a Global System for Mobile Communications (GSM) phone, a mobile broadband system (MBS) phone, a satellite/terrestrial Digital Multimedia Broadcasting (DMB) phone, a Smart phone, a cellular phone, a personal digital assistant (PDA), an MP3 player, a portable media player (PMP), an automotive navigation system (for example, a global positioning system), and the like. Also, the portable device applicable to the above-described embodiments may include a camera (for example a digital camera, digital video camera, etc.), a display panel (for example, a plasma display panel, a LCD display panel, a LED display panel, an OLED display panel, etc.), and the like.

The apparatus and methods used to provide an AR scene according to the above-described example embodiments may use one or more processors, which may include a microprocessor, central processing unit (CPU), digital signal processor (DSP), or application-specific integrated circuit (ASIC), as well as portions or combinations of these and other processing devices.

The terms “module”, and “unit,” as used herein, may refer to, but are not limited to, a software or hardware component or device, such as a Field Programmable Gate Array (FPGA) or Application Specific Integrated Circuit (ASIC), which performs certain tasks. A module or unit may be configured to reside on an addressable storage medium and configured to execute on one or more processors. Thus, a module or unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules/units may be combined into fewer components and modules/units or further separated into additional components and modules.

Each block of the flowchart illustrations may represent a unit, module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

The method for providing the AR scene according to the above-described embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The program instructions may be executed by one or more processors. The described hardware devices may be configured to act as one or more software modules that are recorded, stored, or fixed in one or more computer-readable storage media, in order to perform the operations of the above-described embodiments, or vice versa. In addition, a non-transitory computer-readable storage medium may be distributed among computer systems connected through a network and computer-readable codes or program instructions may be stored and executed in a decentralized manner. In addition, the computer-readable storage media may also be embodied in at least one application specific integrated circuit (ASIC) or Field Programmable Gate Array (FPGA).

Although embodiments have been shown and described, it would be appreciated by those skilled in the art that changes may be made to these embodiments without departing from the principles and spirit of the disclosure, the scope of which is defined by the claims and their equivalents.

What is claimed is:

1. A method for providing an augmented reality (AR) scene, the method comprising:
obtaining real world information associated with a real world;
loading an AR locator representing a scheme for mixing the real world information and at least one virtual object content and the real world information onto an AR container;
obtaining the at least one virtual object content corresponding to the real world information, using the AR locator; and
visualizing AR information by mixing the real world information and the at least one virtual object content based on the AR locator.

2. The method of claim 1, further comprising:
analyzing multimedia information and sensor information included in the real world information to identify the at least one virtual object content corresponding to the multimedia information; and
generating the AR locator based on a result of the analyzing.

3. The method of claim 1, wherein the AR container comprises a first area and a second area independent of one another, and
the loading of the AR locator and the real world information onto the AR container comprises:
loading the real world information onto the first area and loading the AR locator onto the second area, respectively.

4. The method of claim 2, wherein the generating of the AR locator comprises:
generating the AR locator including at least one of a three-dimensional (3D) scene description of the real world information, an AR location representing a location of the at least one virtual object content in the AR information, an AR control representing control information of the at least one virtual object content, and calibration information.

5. The method of claim 4, wherein the AR control comprises at least one of a point of time at which the at least one virtual object content is mixed and an identifier of the at least one virtual object content.

6. The method of claim 5, wherein the point of time at which the at least one virtual object content is mixed comprises:
a start time at which mixing of the at least one virtual object content commences or a stop time at which mixing of the at least one virtual object content terminates.

7. The method of claim 1, wherein the obtaining of the at least one virtual object content comprises:
transmitting a request including an identifier of the at least one virtual object content to a local storage or an AR contents server.

8. The method of claim 1, wherein the at least one virtual object content comprises at least one of:
the identifier, a virtual object, and information about a characteristic of the virtual object of the at least one virtual object content.

9. The method of claim 1, wherein the visualizing of the AR information comprises:
generating AR information by performing rendering on the real world information and the at least one virtual object content based on the AR locator.

10. The method of claim 2, further comprising:
receiving a selection from a user with respect to the visualized AR information for an interaction between the user and the at least one virtual object content; and
correcting the AR locator in response to the selection from the user.

11. The method of claim 8, wherein the virtual object comprises at least one of:
a 3D graphics object, an audio object, a video object, an image object, and a text object.

12. A non-transitory computer-readable medium comprising a program for instructing a computer to perform the method of claim 1.

13. A system for providing an augmented reality (AR) scene, the system comprising:
a real world information obtaining unit to obtain real world information;
an AR container loading unit to load an AR locator representing a scheme for mixing the real world information and at least one virtual object content and the real world information onto an AR container;
a virtual object content obtaining unit to obtain the at least one virtual object content corresponding to the real world information using the AR locator; and
an AR information visualizing unit to visualize AR information by mixing the real world information and the at least one virtual object content based on the AR locator.

14. The system of claim 13, further comprising:
a real world information analyzing unit to analyze multimedia information and sensor information included in the real world information to identify the at least one virtual object content corresponding to the multimedia information; and
an AR locator generating unit to generate the AR locator based on a result of the analyzing.

15. The system of claim 13, wherein the AR container comprises a first area and a second area independent of one another, and
the AR container loading unit comprises:
a loading unit to load the real world information onto the first area and to load the AR locator onto the second area, respectively.

16. The system of claim 13, wherein the virtual object content obtaining unit comprises:
a virtual object content requesting unit to transmit a request including an identifier of the at least one virtual object content to a local storage or an AR contents server.

17. The system of claim 13, further comprising:
a memory to store the AR container and the at least one virtual object content; and
an interface to receive a selection from a user and to display the AR information.

18. A system for providing an augmented reality (AR) scene, the system comprising:
a mobile terminal to capture an image including real world information;
an AR locator which includes information regarding virtual object content corresponding to the captured real world information;
a virtual object content obtaining unit to receive virtual object content corresponding to the real world information using at least one identifier corresponding to the virtual object content; and
an AR information visualizing unit to render the received virtual object content with the real world information using information included in the AR locator.

19. The system of claim 18, wherein the mobile terminal captures the image in real-time, and
the AR locator generates a point of time in which virtual object content is to be mixed with the real world information using three-dimensional graphics corresponding to the real world information, and calibration information which maps virtual object content to the real world information.

20. The system of claim 18, further comprising:
an interface included in the mobile terminal configured to receive an input from a user,
wherein, in response to the user selecting a first virtual object among a plurality of virtual objects displayed on the mobile terminal, a second virtual object changes position relative to the first virtual object.
